(19) United States
(12) Patent Application Publication
(10) Pub. No.: US 2015/0056866 A1
(43) Pub. Date: Feb. 26, 2015

(54) COAXIAL CONNECTOR

(71) Applicant: MURATA MANUFACTURING CO., LTD., Kyoto-fu (JP)

(72) Inventor: Yoshihiro OSAKI, Kyoto-fu (JP)

(73) Assignee: MURATA MANUFACTURING CO., LTD., Kyoto-fu (JP)

(21) Appl. No.: 14/529,445

(22) Filed: Oct. 31, 2014

Related U.S. Application Data
(63) Continuation of application No. PCT/JP2013/066837, filed on Jun. 19, 2013.

(30) Foreign Application Priority Data
Jul. 17, 2012 (JP) 2012-158600

(51) Int. Cl. H01R 33/20; H01R 13/627

(52) U.S. Cl. CPC H01R 33/205; H01R 13/6277
USPC 439/675

(57) ABSTRACT

A coaxial connector capable of reducing a probability of another coaxial connector easily separating from the coaxial connector. A hole into which a probe is inserted toward a downward direction is formed in a main body. An external terminal includes a cylinder portion that surrounds the hole extends in a top-bottom direction, and is inserted into an external terminal and a flat portion that is connected to a lower end portion of the cylinder portion and has a surface, which is oriented upward. A fixed terminal is fixed to the main body. A movable terminal is fixed to the main body, in contact with the fixed terminal, and is separated from the fixed terminal as a result of the probe making contact with the movable terminal. A groove that extends around an outer peripheral surface of the cylinder portion is formed in the outer peripheral surface of the cylinder portion.

### CROSS REFERENCE TO RELATED APPLICATIONS

This application claims benefit of priority to

Japanese Patent Application No. 2012-158600 filed Jul. 17, 2012, and to International Patent Application No. PCT/JP2013/066837 filed on Jun. 19, 2013, the entire content of each of which is incorporated herein by reference.

### TECHNICAL FIELD

The present technical field relates to coaxial connectors, and more particularly to a coaxial connector that is incorporated into a mobile communication device such as a cellular phone and performs switching of signal paths.

### BACKGROUND

A coaxial connector that is described in Japanese Patent No. 4442719 is known as an example of a coaxial connector of the related art. FIG. 7 is a diagram illustrating the sectional structure of a coaxial connector 510 described in Japanese Patent No. 4442719.

As illustrated in FIG. 7(a), the coaxial connector 510 includes a main body 512, an external terminal 514, a movable terminal 520, and a fixed terminal 522. The movable terminal 520 and the fixed terminal 522 are fixed to the main body 512. The movable terminal 520 is pressed into contact with the fixed terminal 522 from below. A hole 534a that extends in the top-bottom direction is formed in the main body 512. The external terminal 514 includes a cylinder portion 532 that is concentric with the hole 534a and a flat portion 531 that is connected to a lower end portion of the cylinder portion 532.

As illustrated in FIG. 7(b), another coaxial connector 540 is to be mounted on the coaxial connector 510, which has the above-described configuration. The other coaxial connector 540 includes a probe 542 and an external terminal 544. The probe 542 is inserted into the hole 534a and presses the movable terminal 520 down. This allows the movable terminal 520 and the fixed terminal 522 to separate from each other and the movable terminal 520 and the probe 542 to be connected to each other. The cylinder portion 532 of the external terminal 514 is inserted into the external terminal 544. This allows the external terminal 514 and the external terminal 544 to be connected to each other.

In the coaxial connector 510 described in Japanese Patent No. 4442719, there is a probability of the other coaxial connector 540 easily separating from the coaxial connector 510. More specifically, a groove 550 is formed in an outer peripheral surface of the cylinder portion 532. A projection 552 that projects inward is formed in a lower end portion of the external terminal 544. When the other coaxial connector 540 is mounted on the coaxial connector 510, the projection 552 is fitted into the groove 550.

However, as illustrated in FIG. 7(b), the groove 550 is formed at the center of the cylinder portion 532 in the top-bottom direction, and thus, the lower end portion of the external terminal 544 is not in contact with the flat portion 531. Thus, the other coaxial connector 540 is supported only by the cylinder portion 532 and is not supported by the flat portion 531. Therefore, there is a probability of the other coaxial connector 540 tilting due to an external force, vibration, or the like and separating from the coaxial connector 510.

### SUMMARY

### Technical Problem

Accordingly, it is an object of the present disclosure to provide a coaxial connector capable of reducing the probability of another coaxial connector easily separating from the coaxial connector.

### Solution to Problem

A coaxial connector according to the present disclosure is a coaxial connector with a switch on and from which another coaxial connector that includes a probe, which has a bar-like shape, and a first external terminal, which has a cylindrical shape and surrounds the probe, is to be mounted and removed and includes a main body that has a hole into which the probe is inserted toward a downward direction, a second external terminal that includes a cylinder portion, the cylinder portion surrounding the hole when seen in plan view from above, extending in a top-bottom direction, and being inserted into the first external terminal and a base portion that is connected to a lower end portion of the cylinder portion and has a surface, which is oriented upward, a fixed terminal that is fixed to the main body, and a movable terminal that is fixed to the main body, in contact with the fixed terminal, and is separated from the fixed terminal as a result of the probe making contact with the movable terminal. A groove that is adjacent to the base portion and that extends around an outer peripheral surface of the cylinder portion when seen in plan view from above is formed in the outer peripheral surface of the cylinder portion.

### Advantageous Effects of Disclosure

According to the present disclosure, the probability of another coaxial connector easily separating from a coaxial connector can be reduced.

### BRIEF DESCRIPTION OF THE DRAWINGS

FIGS. 1(a) and 1(b) are external perspective views of a coaxial connector according to an embodiment of the present disclosure.

FIG. 2 is an exploded perspective view of the coaxial connector.

FIG. 3 is an exploded perspective view of the coaxial connector.

FIG. 4 is an external perspective view illustrating a state where a movable terminal and a fixed terminal are mounted on a lower case.

FIG. 5 is an external perspective view illustrating a state where the movable terminal and the fixed terminal are mounted on an upper case.

FIG. 6(a) is a diagram illustrating the sectional structure of the coaxial connector in the xz plane when another coaxial connector is not mounted on the coaxial connector. FIG. 6(b) is a diagram illustrating the sectional structure of the coaxial connector in the xz plane when the other coaxial connector is mounted on the coaxial connector.

FIGS. 7(a) and 7(b) are diagrams illustrating the sectional structure of a coaxial connector that is described in Japanese Patent No. 4442719.

### DETAILED DESCRIPTION

A coaxial connector according to an embodiment of the present disclosure will be described below with reference to the drawings.

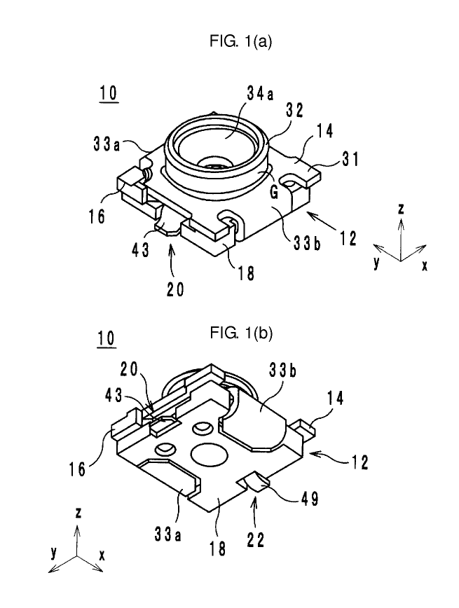

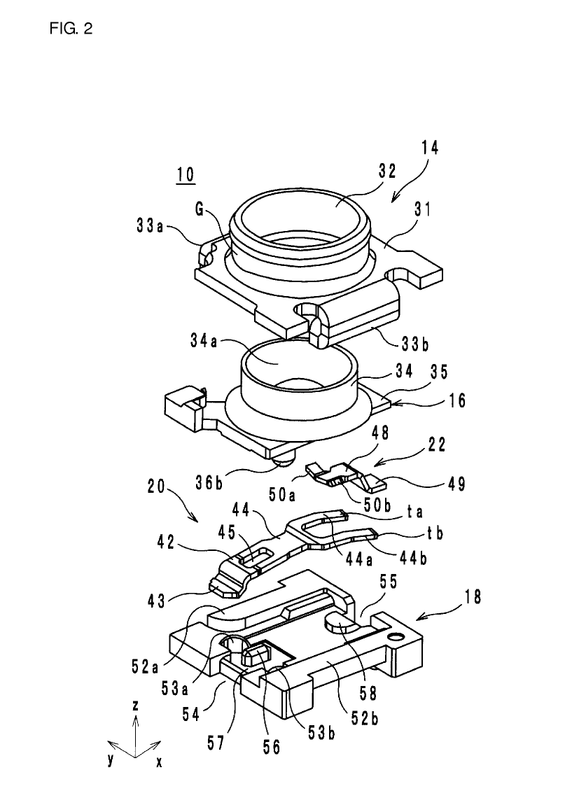

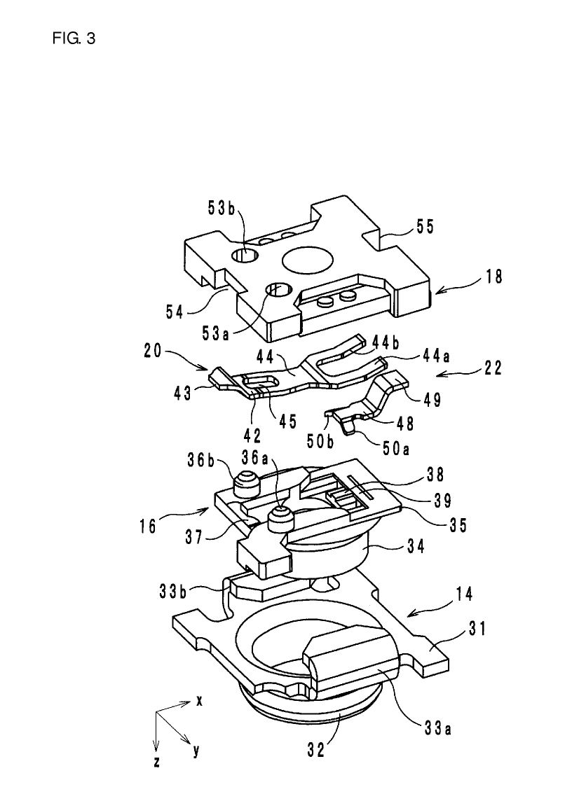

FIGS. 1(a) and 1(b) are external perspective views of a coaxial connector 10 according to the embodiment of the present disclosure. FIG. 2 and FIG. 3 are exploded perspective views of the coaxial connector 10. Details of the coaxial connector 10 will be described below. In FIG. 1(a) to FIG. 3, the direction in which an external terminal 14, an upper case 16, and a lower case 18 are stacked on top of one another is a z-axis direction. A positive z-axis direction is a direction from the lower case 18 toward the external terminal 14. The direction in which a movable terminal 20 and a fixed terminal 22 are arranged next to each other is an x-axis direction, and a direction that is perpendicular to the x-axis direction and the z-axis direction is a y-axis direction. A positive x-axis direction is a direction from the movable terminal 20 toward the fixed terminal 22.

As illustrated in FIGS. 1(a) and 1(b), the coaxial connector 10 includes a main body 12, the external terminal 14, which is made from a metal, the movable terminal 20, which is made from a metal (e.g., stainless steel SUS301), and the fixed terminal 22 and has a size of 2 mm×2 mm×0.9 mm. As illustrated in FIG. 2, the main body 12 includes the upper case 16 and the lower case 18, which are made of a resin and which are stacked one on top of the other in this order from the positive z-axis direction toward the negative z-axis direction.

As illustrated in FIG. 2, the lower case 18 has a rectangular shape and has projections 52a and 52b, which are used for positioning of the upper case 16, on a surface of the lower case 18 on the positive side in the z-axis direction. Each of the projections 52a and 52b extends in the x-axis direction along one of the sides of the lower case 18 that are positioned at ends in the y-axis direction. In addition, holes 53a and 53b are formed in the lower case 18.

Furthermore, as illustrated in FIG. 2, rectangular cutout portions 54 and 55 that are used for causing the movable terminal 20 and the fixed terminal 22 to be drawn out to the outside are each formed in a center portion of one of two sides of the lower case 18, which extend in the y-axis direction. A projection 56 that is used for positioning of the movable terminal 20 is formed in the vicinity of the cutout portion 54 on the positive side in the x-axis direction. A fixing surface 57 that is used for fixing the movable terminal 20 in place is formed between the cutout portion 54 and the projection 56. On the other hand, a fixing surface 58 that is used for fixing the fixed terminal 22 in place is formed in the vicinity of the cutout portion 55 on the negative side in the x-axis direction.

As illustrated in FIG. 2, the upper case 16 includes a cylinder portion 34 and a cover portion 35. The cover portion 35 is a plate-shaped member having an external shape that follows the shapes of the projections 52a and 52b and is fitted into a space between the projections 52a and 52b. The cylinder portion 34 projects toward the positive z-axis direction at the center of the cover portion 35. The cylinder portion 34 has a hole 34a that is open toward the positive z-axis direction so as to have an inverted cone-like shape and that has a circular cross section in the xy plane. The hole 34a extends all the way through the upper case 16. A probe of another coaxial connector is inserted into the hole 34a from the opening, which has an inverted cone-like shape, toward the negative z-axis direction.

In addition, as illustrated in FIG. 3, two ribs 36a and 36b each of which has a columnar shape and projects toward the negative z-axis direction are disposed on a surface of the upper case 16 on the negative side in the z-axis direction. The ribs 36a and 36b are respectively inserted into the holes 53a and 53b, which are formed in the lower case 18, in such a manner as to position the upper case 16 and the lower case 18.

As illustrated in FIG. 3, in the surface of the upper case 16 on the negative side in the z-axis direction, a fixing surface 37 that is used for fixing the movable terminal 20 in place is formed in the vicinity of an end portion on the negative side in the x-axis direction. When the coaxial connector 10 is assembled, the fixing surface 37 clamps the movable terminal 20 together with the fixing surface 57 in such a manner as to fix the movable terminal 20 in place. Similarly, in the surface of the upper case 16 on the negative side in the z-axis direction, a fixing surface 39 that is used for fixing the fixed terminal 22 in place is formed in the vicinity of an end portion on the positive side in the x-axis direction. When the coaxial connector 10 is assembled, the fixing surface 39 clamps the fixed terminal 22 together with the fixing surface 58 in such a manner as to fix the fixed terminal 22 in place. In addition, a placement portion 38 is arranged adjacent to the fixing surface 39 in the negative x-axis direction. The placement portion 38 is disposed on the surface of the upper case 16 on the negative side in the z-axis direction in such a manner as to project toward the negative z-axis direction, and a fixed portion 48 and contact portions 50a and 50b of the fixed terminal 22, which will be described later, are to be placed on the placement portion 38. The placement portion 38 has a step-like shape in which the width of the placement portion 38 in the y-axis direction becomes narrower in the negative z-axis direction.

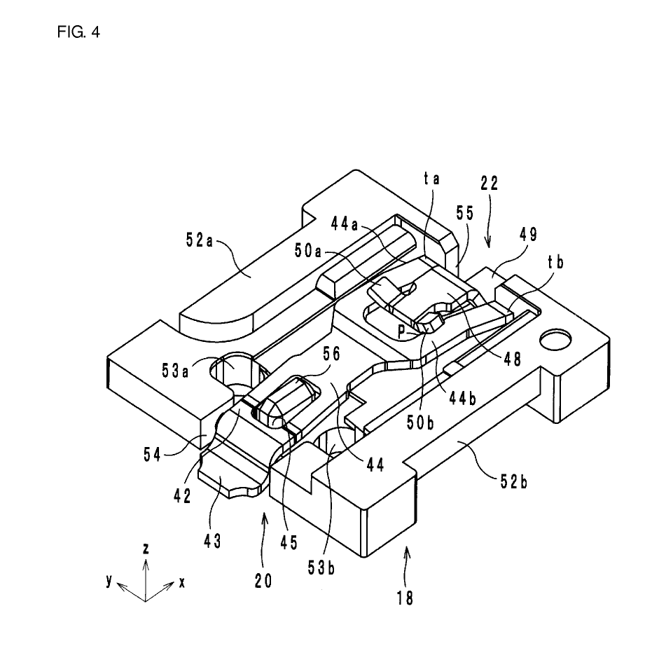

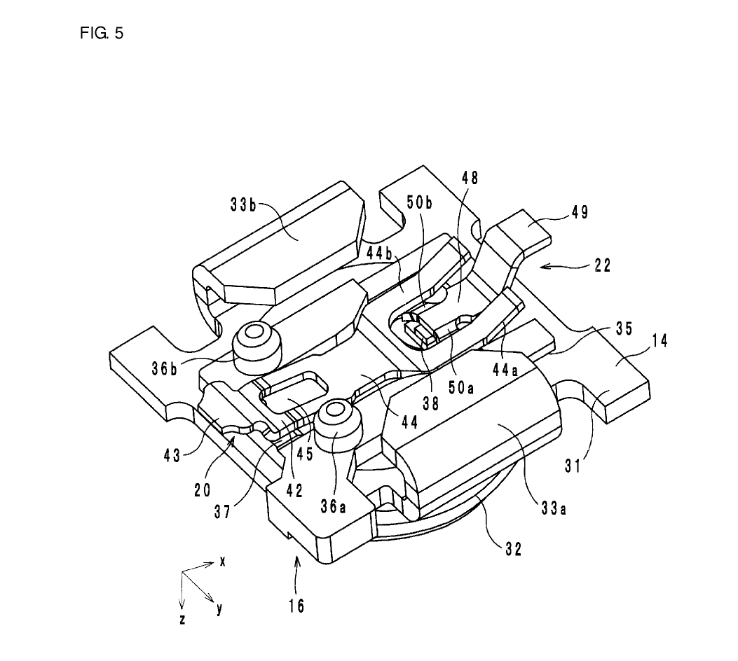

The movable terminal 20 and the fixed terminal 22 will now be described with reference to FIG. 1(a) to FIG. 5. FIG. 4 is an external perspective view illustrating a state where the movable terminal 20 and the fixed terminal 22 are mounted on the lower case 18. FIG. 5 is an external perspective view illustrating a state where the movable terminal 20 and the fixed terminal 22 are mounted on the upper case 16.

The fixed terminal 22 is formed by performing punching and bending on a metal plate having a flat plate-like shape and, as illustrated in FIG. 2 and FIG. 3, includes the fixed portion 48, a lead portion 49, and the contact portions 50a and 50b. The fixed portion 48 is a flat portion that is fixed onto the main body 12 by being clamped between the fixing surface 39 and the fixing surface 58 when the coaxial connector 10 is assembled. The lead portion 49 is connected to the fixed portion 48 on the positive side in the x-axis direction, and is formed in an L shape by performing bending thereon. In addition, as illustrated in FIG. 1(b) and FIG. 4, the lead portion 49 is exposed through the cutout portion 55 to outside the main body 12 when the coaxial connector 10 is assembled. As illustrated in FIG. 4 and FIG. 5, the contact portions 50a and 50b extend from the fixed portion 48 toward the positive y-axis direction and the negative y-axis direction, respectively, and are bent in the positive z-axis direction with respect to the fixed portion 48. In addition, a portion of each of the contact portions 50a and 50b that is oriented in the negative z-axis direction is brought into contact with the movable terminal 20. The contact portions 50a and 50b are arranged in such a manner as to correspond to branch portions 44a and 44b, which will be described later, respectively. A bending line between the contact portion 50a and the fixed portion 48, and a bending line between the contact portion 50b, and the fixed portion 48 are parallel to the x-axis direction. As illustrated in FIG. 5, the fixed portion 48 between the contact portions 50a and 50b and the contact portions 50a and 50b are to be placed on the placement portion 38, which has a shape that follows the shapes of the contact portions 50a and 50b and the fixed portion 48.

The movable terminal 20 is formed by performing punching and bending on a springy metal plate in such a manner as to form the metal plate into a predetermined shape and, as illustrated in FIG. 2 and FIG. 3, includes a fixed portion 42, a lead portion 43, and a plate spring portion 44. The fixed portion 42 is a flat portion that is fixed onto the main body by being clamped between the fixing surface 37 and the fixing surface 57 when the coaxial connector 10 is assembled. The lead portion 43 is connected to the fixed portion 42 on the negative side in the x-axis direction and is formed in an L shape by performing bending thereon. As illustrated in FIG. 1(a), FIG. 1(b) and FIG. 4, the lead portion 43 is exposed through the cutout portion 54 to outside the main body 12 when the coaxial connector 10 is assembled.

As illustrated in FIG. 4, the plate spring portion 44 linearly extends in the x-axis direction from the fixed portion 42 toward the fixed terminal 22 and is in contact with the contact portions 50a and 50b of the fixed terminal 22, and end portions ta and tb of the plate spring portion 44 are slidably in contact with the lower case 18. More specifically, the plate spring portion 44 includes the branch portions 44a and 44b that are formed as a result of the plate spring portion 44 branching into two portions on the side on which the end portions to and tb are present (the positive side in the x-axis direction). The fixed terminal 22 is positioned between the branch portions 44a and 44b, and the contact portions 50a and 50b of the fixed terminal 22 extend in the y-axis direction toward the positive z-axis direction in such a manner that the contact portions 50a and 50b are respectively superposed with the branch portions 44a and 44b when seen in plan view in the z-axis direction. The plate spring portion 44 is curved in such a manner as to project in the positive z-axis direction. Thus, the branch portions 44a and 44b are respectively pressed into contact with the contact portions 50a and 50b from the negative side in the z-axis direction by an urging force of the plate spring portion 44. This allows the movable terminal 20 and the fixed terminal 22 to be electrically connected to each other.

In addition, a hole 45 is formed across the plate spring portion 44 and the fixed portion 42. As illustrated in FIG. 4, the projection 56 is inserted into the hole 45. As a result, the movable terminal 20 is positioned in the xy plane.

Regarding the movable terminal 20 and the fixed terminal 22, which have the above-described configurations, as illustrated in FIG. 5, the movable terminal 20 is mounted on the upper case 16 after the fixed terminal 22 has been mounted on the upper case 16. As a result, portions of the branch portions 44a and 44b on the positive side in the z-axis direction and portions of the contact portions 50a and 50b on the negative side in the z-axis direction are respectively brought into contact with each other.

The external terminal 14 which makes contact with an outer conductor of the other coaxial connector, is formed by performing punching, bending, drawing, and the like on a metal plate made of stainless steel (e.g., SUS301), and, as illustrated in FIG. 1(a) and FIG. 2, includes a flat portion 31, a cylinder portion 32, and leg portions 33a and 33b. The external terminal 14 usually functions asa ground, and an outer surface of the external terminal 14 is coated as may be necessary.

The cylinder portion 32 is a cylinder member that is concentric with the cylinder portion 34 and that extends in the z-axis direction and is fitted into the outer conductor of the other coaxial connector. Accordingly, the cylinder portion 32 surrounds the hole 34a when seen in plan view in the z-axis direction.

The flat portion 31 (base portion) is a plate-shaped member having a surface that is oriented in the positive z-axis direction and is connected to an end portion of the cylinder portion 32 on the negative side in the z-axis direction. The flat portion 31 covers the upper case 16 from the positive side in the z-axis direction. Each of the leg portions 33a and 33b are disposed on one of the sides of the flat portion 31 that are positioned at ends in the y-axis direction. The leg portions 33a and 33b are formed by bending portions of a plate-shaped body that extends in the y-axis direction from the flat portion 31 and, as illustrated in FIG. 1(a), clamp the upper case 16 and the lower case 18 in such a manner as to fix the upper case 16 and the lower case 18 in place.

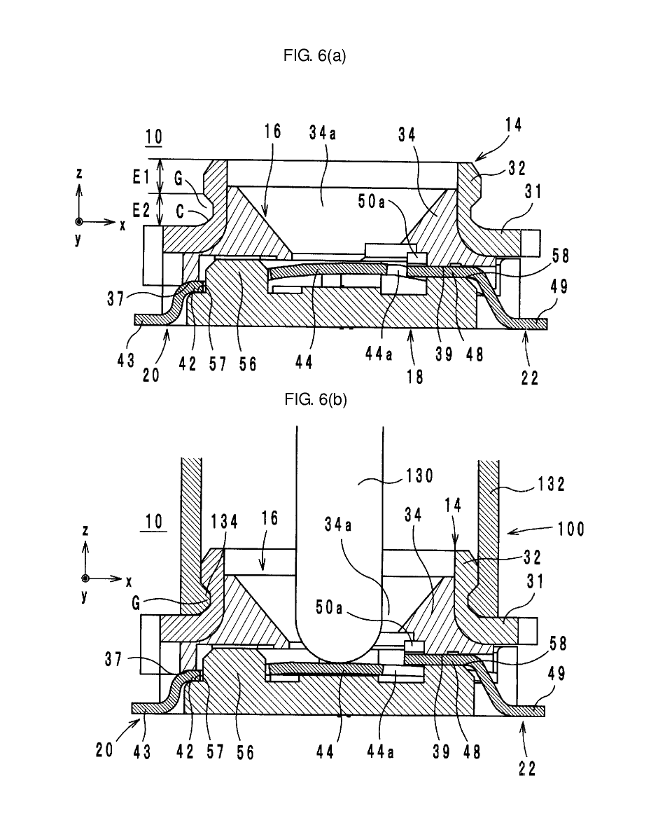

The configuration of the external terminal 14 will now be described in further detail with reference to FIGS. 6(a) and 6(b). FIG. 6(a) is a diagram illustrating the sectional structure of the coaxial connector 10 in the xz plane when another coaxial connector 100 is not mounted on the coaxial connector 10. FIG. 6(b) is a diagram illustrating the sectional structure of the coaxial connector 10 in the xz plane when the other coaxial connector 100 is mounted on the coaxial connector 10.

As illustrated in FIG. 6(a), a groove G that is formed by deforming a portion of an outer peripheral surface of the cylinder portion 32 toward the center of the cylinder portion 32 is formed in the outer peripheral surface of the cylinder portion 32 of the external terminal 14. As illustrated in FIG. 1(a), FIG. 2, and FIG. 6, the groove G has a ring-like shape that extends around the outer peripheral surface of the cylinder portion 32 when seen in plan view in the z-axis direction. In addition, the groove G is formed in an end portion of the cylinder portion 32 on the negative side in the z-axis direction and is adjacent to the flat portion 31. In the cylinder portion 32, an area in which the groove G is formed will be hereinafter referred to as an area E2. In addition, in the cylinder portion 32, an area that is positioned further toward the positive side in the z-axis direction than the area E2 will be referred to as an area E1.

As illustrated in FIG. 6(a), the groove G is not formed in the area El in the cylinder portion 32. Thus, the thickness of the cylinder portion 32 in the area E1 is larger than the thickness of the cylinder portion 32 in the area E2.

As illustrated in FIG. 6(a), in the cylinder portion 32, a joint portion C in which the cylinder portion 32 and the flat portion 31 are joined to each other is tapered toward the positive z-axis direction. In addition, the joint portion C forms an inner peripheral surface (side surface) of the groove G on the negative side in the z-axis direction.

The coaxial connector 10, which has the above-described configuration, is assembled in the following manner. As illustrated in FIG. 5, the fixed terminal 22 is positioned and mounted on the upper case 16, and after that, the movable terminal 20 is positioned and mounted on the upper case 16. Note that, although the leg portions 33a and 33b are bent in FIG. 5, in practice, the leg portions 33a and 33b are not bent at this stage.

Next, as illustrated in FIG. 5, the external terminal 14 is mounted on the upper case 16 from the positive side in the z-axis direction. In this case, the cylinder portion 34 is inserted into the cylinder portion 32. After that, as illustrated in FIG. 3, the lower case 18 is stacked on the upper case 16 from the negative side in the z-axis direction. In this case, the ribs 36a and 36b are respectively inserted into the holes 53a and 53b.

Finally, the leg portions 33a and 33b of the external terminal 14 are crimped, and as a result, the coaxial connector 10 having a structure such as that illustrated in FIGS. 1(a) and 1(b) can be obtained.

Operation of the coaxial connector 10 when the other coaxial connector 100 is mounted on and removed from the coaxial connector 10 will now be described with reference to FIGS. 6(a) and 6(b). As illustrated in FIG. 6(b), the other coaxial connector 100 includes a probe 130 and an external terminal 132. The probe 130 is a bar-shaped member that extends in the z-axis direction. A signal is to be applied to the probe 130. The external terminal 132 is a member having a cylindrical shape that surrounds the probe 130 and extends in the z-axis direction. In addition, a projection 134 is formed on the external terminal 132. When seen in plan view in the z-axis direction, the projection 134 extends around an inner peripheral surface of an end portion of the external terminal 132 on the negative side in the z-axis direction and projects toward the center of the external terminal 132. The external terminal 132 is maintained at ground potential.

As illustrated in FIG. 6(a), when the other coaxial connector 100 is not mounted, the movable terminal 20 is in a state where a center portion thereof in the x-axis direction bulges toward the positive z-axis direction. As a result, the branch portions 44a and 44b (only the branch portion 44a is illustrated in FIGS. 6(a) and 6(b)) are respectively pressed into contact with the contact portions 50a and 50b (only the contact portion 50a is illustrated in FIGS. 6(a) and 6(b)) by the urging force of the plate spring portion 44, and the movable terminal 20 and the fixed terminal 22 are electrically connected to each other.

On the other hand, when the other coaxial connector 100 is mounted, the probe 130 of the other coaxial connector 100 is inserted from the positive z-axis direction toward the negative z-axis direction via the hole 34a. This enables the probe 130 to make contact with the plate spring portion 44 and to press the plate spring portion 44 down in the negative z-axis direction. In other words, the plate spring portion 44 is displaced in a direction away from the fixed terminal 22 as a result of the probe 130 making contact with the plate spring portion 44. As a result, as illustrated in FIG. 6(b), the branch portions 44a and 44b of the plate spring portion 44 are separated from the contact portions 50a and 50b, and the electrical connection between the movable terminal 20 and the fixed terminal 22 is cut, and, on the other hand, the probe 130 and the movable terminal 20 are electrically connected to each other.

In addition, as illustrated in FIG. 6(b), the external terminal 14 is inserted into the external terminal 132 of the other coaxial connector 100. In this case, the projection 134 of the external terminal 132 is fitted into the groove G. An end portion of the external terminal 132 on the negative side in the z-axis direction is in contact with the flat portion 31. This allows the external terminal 14 and the external terminal 132 to be fitted to each other and electrically connected to each other.

When the other coaxial connector 100 is removed from the coaxial connector 10, as illustrated in FIG. 6(a), a center portion of the plate spring portion 44 in the x-axis direction moves toward the positive z-axis direction so as to return to the original position. This allows the movable terminal 20 and the fixed terminal 22 to be electrically connected to each other again, and, on the other hand, the electrical connection between the probe 130 and the movable terminal 20 is cut.

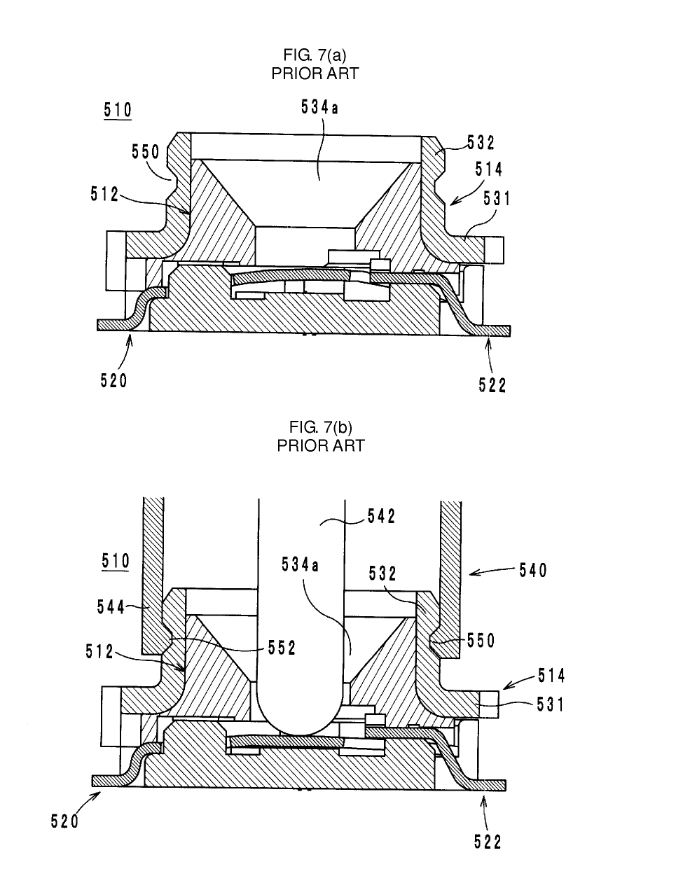

According to the coaxial connector 10, which has the above-described configuration, the probability of the other coaxial connector 100 easily separating from the coaxial connector 10 can be reduced. More specifically, as illustrated in FIG. 7(b), in the coaxial connector 510 described in Japanese Patent No. 4442719, since the groove 550 is formed at the center of the cylinder portion 532 in the top-bottom direction, the lower end portion of the external terminal 544 is not in contact with the flat portion 531. Thus, the other coaxial connector 540 is supported only by the cylinder portion 532 and is not supported by the flat portion 531. Therefore, there is a probability of the other coaxial connector 540 tilting due to an external force, vibration, or the like and separating from the coaxial connector 510.

On the other hand, in the coaxial connector 10, the groove G is adjacent to the flat portion 31. Thus, when the projection 134 of the other coaxial connector 100 is fitted to the groove G, the end portion of the external terminal 132 on the negative side in the z-axis direction is in contact with the flat portion 31. This enables the other coaxial connector 100 to be supported by the flat portion 31 and the cylinder portion 32. As a result, according to the coaxial connector 10, the probability of the other coaxial connector 100 easily separating from the coaxial connector 10 can be reduced.

In addition, in the coaxial connector 10, the groove G is formed further toward the negative side in the z-axis direction than the groove 550 of the coaxial connector 510. Accordingly, in the coaxial connector 10, the height of the cylinder portion 32 in the z-axis direction is small. As a result, a reduction in the height of the coaxial connector 10 is facilitated.

### INDUSTRIAL APPLICABILITY

The present disclosure is useful in coaxial connectors, and in particular, the present disclosure has an advantage of effectively reducing a probability of another coaxial connector easily separating from such coaxial connectors.

1. A coaxial connector with a switch on and from which another coaxial connector that includes a probe and a first external terminal, which has a cylindrical shape and surrounds the probe, is to be mounted and removed, the coaxial connector comprising:
a main body having a hole into which the probe is inserted toward a downward direction;
a second external terminal including
a cylinder portion, the cylinder portion surrounding the hole when seen in plan view from above, extending in a top-bottom direction, and being inserted into the first external terminal, and
a base portion connected to a lower end portion of the cylinder portion and having a surface, which is oriented upward;
a fixed terminal fixed to the main body; and
a movable terminal fixed to the main body, in contact with the fixed terminal, and being separated from the fixed terminal as a result of the probe making contact with the movable terminal, and
a groove adjacent to the base portion and extending around an outer peripheral surface of the cylinder portion when seen in plan view from above being formed in the outer peripheral surface of the cylinder portion.

2. The coaxial connector according to claim 1,
wherein a projection is formed to extend around an inner peripheral surface of an end portion of the first external terminal when seen in plan view from below, and
wherein the projection is fitted into the groove.

3. The coaxial connector according to claim 1,
wherein a joint portion in the cylinder portion in which the cylinder portion and the base portion are joined to each other is tapered in an upward direction and forms an inner peripheral surface of the groove.
